(19) United States
(12) Patent Application Publication
(10) Pub. No.: US 2007/0054973 A1
(43) Pub. Date: Mar. 8, 2007

(54) Process for producing polyurethane foam

(76) Inventors: Shuso Iyoshi, Ohtake-shi (JP); Nobuyuki Watanabe, Ohtake-shi (JP)

Correspondence Address: BIRCH STEWART KOLASCH & BIRCH, PO BOX 747, FALLS CHURCH, VA, 22040-0747, US

(21) Appl. No.: 10/575,620

(22) PCT Filed: Oct. 15, 2004
(86) PCT No.: PCT/JP04/15649

§ 371 Date: Apr. 13, 2006

(30) Foreign Application Priority Data
Oct. 17, 2003 (JP) 2003-358420

(51) Int. Cl. C08G 18/00

(52) U.S. Cl. 521/172

(57) ABSTRACT

The present invention provides a process for producing a polyurethane foam, which comprises allowing an organic polyisocyanate component to react with a polyol component in the presence of a catalyst with water as a foaming agent, wherein the polyol component comprises at least 30% by weight of a copolymerized lactone polyol having a hydroxyl value of 20 to 350 KOHmg/g and being in the form of a liquid at an ordinary temperature, the copolymerized lactone polyol is obtained by ring opening copolymerization of ε-caprolactone and δ-valerolactone in a molar ratio [ε-caprolactone/δ-valerolactone] of 80/20 to 20/80 with a low molecular weight compound having at least two active hydrogen groups as an initiator; and the hydroxyl value of the polyol component is 40 to 400 KOHmg/g. Thus, a soft polyurethane foam excellent in mechanical properties can be produced with the use of water only as a foaming agent without the use of as a foaming agent, chlorofluorocarbons causing ozone layer destruction and further without the use of low-boiling point organic solvents inviting the danger of fire.

### TECHNICAL FIELD

The present invention relates to a process for producing a polyurethane foam, the process which does not require any chlorofluorocarbon chemicals and low-boiling point organic solvents as a foaming agent. The polyurethane foam is used as a cushioning material, a soundproof (or sound insulating) material, a damping material, a sealing material, a building heat insulator and various industrial materials, and is excellent in mechanical properties.

### BACKGROUND ART

A polyurethane foam is, for example, as described in Japanese Patent Application Laid-Open No. 25243/1993 (JP-5-25243A), produced by allowing an organic polyisocyanate component to react with a polyol component in the presence of a foaming agent (or a blowing agent), a foam control agent, a catalyst, or others. In particular, a stable cellular material (or foam body) is obtained by using a chlorofluorocarbon chemical such as trichloromonofluoromethane as a foaming agent. However, Montreal Protocol on Substances that Deplete the Ozone Layer came into force in 1989, and the use of specific chlorofluorocarbon chemicals including trichloromonofluoromethane was totally abolished by the late 20th century. In late years, therefore, processes for producing a polyurethane foam by using water, a low-boiling point organic solvent, or a combination of water and a low-boiling point organic solvent as a foaming agent are proposed in order to reduce the amount of chlorofluorocarbons. However, such processes involve not only danger of fire due to inflammability of the low-boiling point organic solvent to be used as a foaming agent, but also difficulty in obtaining a cellular material having the same stability as a polyurethane foam produced by using chlorofluorocarbon chemicals.

Generally, in a foaming process using water as a foaming agent, since a chlorofluorocarbon which also serves as a solvent or a low-boiling point organic solvent is not used as a foaming agent, there is the problem that the viscosity of a polyol mixture becomes higher. Therefore, in the case of mechanically mixing an organic polyisocyanate component and a polyol component by a foaming machine or other means, these components cannot be sufficiently mixed together, and usable polyol components are limited to a liquid one having a low viscosity at an ordinary temperature (or room temperature). Accordingly, the polyol component has been limited to a polyoxyalkylene polyether polyol as represented by an adduct of trimethylolpropane with propylene oxide.

However, since a polyurethane foam produced by using such a polyoxyalkylene polyether polyol (which is a polyfunctional ether-series polyol) alone as the polyol component is inferior in mechanical strength, heat resistance, oil resistance and weather resistance, a polyester polyol is used in combination with the polyoxyalkylene polyether polyol in order to supplement these physical properties.

For example, Japanese Patent Application Laid-Open No. 25327/1998 (JP-10-25327A) discloses a method for improving mechanical properties (e.g., elongation) and weather resistance in a soft polyurethane foam for a speaker edge, the method which comprises a combination use of a polyether polyol and a polyester polyol containing a hydrocarbon unit having not less than 5 carbon atoms as polyol components. However, a polyester polyol is generally high in crystallinity, and in the form of a wax at an ordinary temperature in many cases. Additionally, in order to obtain a liquid polyester polyol, there is used a compound having a branched side chain in a hydrocarbon between ester bonds constituting the polyester polyol, as the polyester polyol.

In the case of providing a branched side chain between ester bonds of the compound, as the branched side chain is longer, some problems arise. That is, the mechanical properties, particularly abrasion resistance or rebound resilience, are deteriorated, and the viscosity increases.

Moreover, JP-5-25243A discloses that brittleness and compressive strength of a hard polyurethane foam produced with the use of water as a foaming agent is improved by using a polyol mixture containing a polyether polyol in which a polyvinyl filler having a hydroxyl value of 350 to 500 is grafted. Further, Japanese Patent No.91452/1995 (JP-7-91452B) discloses that mechanical strength, brittleness, and heat resistance are improved by using a polyol mixture containing an alkylene oxide adduct of a specific dihydric phenol. However, the use of the special polyol as described above involves increase in the viscosity of the polyol mixture, resulting in difficulty of foaming control. Further, there is a possibility that separation of the polyol mixture occurs. Furthermore, in order to lower the viscosity of the polyol mixture, a flame retardant such as a chlorinated paraffin, trischloroethyl phosphate or trischloropropyl phosphate, a surfactant such as nonyl phenol ether, a viscosity decreaser such as propylene carbonate, or others is used. However, since the viscosity decreaser does not take part in the reaction of the urethane, physical properties of the obtained urethane foam are inevitably decreased.

### DISCLOSURE OF THE INVENTION

In the light of problems in the above background art as background, the present invention provides a process for producing a polyurethane foam excellent in workability, wherein a reaction solution which is handled in a foaming step has a low viscosity at an ordinary temperature (or room temperature) even in the case of using water as a foaming agent. A polyurethane foam produced in accordance with the production process of the present invention is excellent in mechanical properties.

According to a first aspect of the present invention, there is provided a process for producing a polyurethane foam, which comprises allowing an organic polyisocyanate component to react with a polyol component in the presence of a catalyst with water as a foaming agent, wherein the polyol component comprises at least 30% by weight of a copolymerized lactone polyol having a hydroxyl value of 20 to 350 KOHmg/g and being in the form of a liquid at an ordinary temperature (or room temperature), and the copolymerized lactone polyol is obtained by ring opening copolymerization of ε-caprolactone and δ-valerolactone in a molar ratio [ε-caprolactone/δ-valerolactone] of 80/20 to 20/80 with a low molecular weight compound having at least two active hydrogen groups as an initiator; and the hydroxyl value of the polyol component is 40 to 400 KOHmg/g.

According to a second aspect of the present invention, there is provided a process for producing a polyurethane foam described in the first aspect of the invention, wherein the low molecular weight compound having at least two active hydrogen groups comprises at least one member selected from the group consisting of ethylene glycol, diethylene glycol, 1,4-butanediol, 1,5-pentanediol, neopentyl glycol, 1,6-hexanediol, glycerin, trimethylolpropane, triethanolamine and pentaerythritol.

According to a third aspect of the present invention, there is provided a process for producing a polyurethane foam described in the first or second aspect of the invention, wherein the viscosity of the copolymerized lactone polyol is not more than 20,000 mPa·s at 25° C.

### BEST MODE FOR CARRYING OUT THE INVENTION

Hereinafter, the embodiments of the present invention will be illustrated.

The present invention is characterized by using a copolymerized lactone polyol which does not increase a viscosity of a reaction solution even when the copolymerized lactone polyol is allowed to react with an organic polyisocyanate component with the use of water as a foaming agent in a production step of a polyurethane foam. Water as the foaming agent reacts with the organic polyisocyanate component to generate carbon dioxide gas, and by the generated gas, the generated polyurethane is allowed to foam during the generation process, resulting in a polyurethane foam. The amount of water to be used relative to 100 parts by weight of the polyol component is not more than 10 parts by weight, and preferably 2 to 8 parts by weight. When the amount of water exceeds 10 parts by weight, it is difficult to obtain a uniform cellular material because of too large foaming magnification. Moreover, it is not preferred that the amount of water is less than 2 parts by weight, because the density of the obtained polyurethane foam becomes too large so that characteristics as a cellular material are sometimes lost.

The copolymerized lactone polyol to be used in the present invention is obtained by a ring opening copolymerization of ε-caprolactone and δ-valerolactone with a low molecular weight compound having at least two active hydrogen groups as an initiator, wherein the initiator has a molecular weight of not more than 1000, preferably not more than 500, and more preferably not more than 200, and comprises, for example, at least one member selected from the group consisting of ethylene glycol, diethylene glycol, propylene glycol, dipropylene glycol, 1,4-butanediol, 1,5-pentanediol, neopentyl glycol, 1,6-hexanediol, glycerin, trimethylolpropane, triethanolamine and pentaerythritol. Further, if necessary, a small amount of other cyclic lactone compound(s) may be added as a copolymerizable monomer.

Optionally added other cyclic lactone compound(s) may include trimethyl-ε-caprolactone, monomethyl-ε-caprolactone, γ-butyrolactone, monomethyl-δ-valerolactone, and the like. In the present invention, the copolymerized lactone polyol obtained from ε-caprolactone and δ-valerolactone has a low viscosity, and by using the polyol, the obtained polyurethane foam is excellent in mechanical properties.

As the process for producing the copolymerized lactone polyol to be used in the production process of the present invention, there is used a generally practiced ring-opening addition polymerization of a cyclic lactone compound. The copolymerized lactone polyol may be obtained by a continuous or batch reaction which comprises mixing an initiator, ε-caprolactone and δ-valerolactone, and other cyclic lactone compound(s) to be optionally added, stirring the mixture at a temperature of 120° C. to 230° C. (more preferably 140° C. to 220° C.) for several hours, preferably with the use of a polymerization catalyst. As the polymerization catalyst, various organic or inorganic metal compounds, and others may be used. Specifically, the polymerization catalyst may include an organic titanium-containing compound such as tetrabutyl titanate, tetraisopropyl titanate or tetraethyl titanate, an organic tin compound such as dibutyltin oxide, dibutyltin laurate, stannous octanoate or mono-n-butyltin fatty acid salt, a stannous halide such as stannous chloride, stannous bromide or stannous iodide, and others. The amounts of these catalysts to be used are 0.1 ppm to 1,000 ppm, and preferably 0.5 ppm to 500 ppm relative to the amount of the starting material.

It is essential that the copolymerization proportion [ε-caprolactone/δ-valerolactone] is 80/20 to 20/80 as a molar ratio. In the case where the copolymerization proportion is out of the above range, only highly crystalline copolymerized lactone polyol is obtained. As a result, it is not preferred because a liquid matter is not obtained at an ordinary temperature. In the case of adding other cyclic lactone compound(s), the amount thereof is preferably not more than 20% by mol in 100% by mol of the whole mixture of the cyclic lactone compound.

It is essential that the hydroxyl value of the copolymerized lactone polyol to be used in the present invention is 20 to 350 KOHmg/g. In particular, the hydroxyl value is preferably 40 to 200 KOHmg/g. A copolymerized lactone polyol having a hydroxyl value of less than 20 KOHmg/g is not preferred because the mixing operation of the copolymerized lactone polyol and the organic polyisocyanate component is hindered due to the higher viscosity of the copolymerized lactone polyol. Moreover, a copolymerized lactone polyol having a hydroxyl value over 350KOHmg/g is not preferred because the obtained polyurethane foam hardens too much. It is essential that the hydroxyl value of the whole polyol component containing the copolymerized lactone polyol is 40 to 400 mgKOH/g. The polyol component having a hydroxyl value more than 400 mgKOH/g makes the obtained polyurethane foam rigid, and such a polyurethane foam is not preferred due to lack of elasticity. For example, in the case of a hard polyurethane foam, a polyurethane foam obtained from a polyol component having a hydroxyl value more than 400 mgKOH/g is not preferred because of lowering the compressive strength. When the hydroxyl value of the whole polyol component is less than 40 KOHmg/g, the obtained polyurethane foam unpreferably becomes too soft to ensure necessary hardness.

The polyol component to be employed in combination with the copolymerized lactone polybl used in the present invention is not particularly limited to a specific one as far as the component is a polyfunctional polyol component to be generally used in a polyurethane foam. For example, such a polyfunctional polyol component may include a polyether polyol obtained by adding one or more compound(s) such as ethylene oxide, propylene oxide or butylene oxide with the use of an initiator such as glycerin, trimethylolpropane, sorbitol, ethylenediamine, pentaerythritol, methyl glucoside, tolylenediamine, Mannich, sucrose, or the like; and an aromatic polyester polyol containing a waste PET, DMT process residue and phthalic anhydride as a base component. Among them, a product obtained by adding ethylene oxide or propylene oxide to glycerin, ethylenediamine or trimethylolpropane is particularly preferred in view of the low viscosity. Moreover, the aromatic polyester polyol may be used within a range at which the viscosity of the whole polyol component mixture is acceptable.

As the organic polyisocyanate component to be used in the present invention, a commonly used polyisocyanate such as an aromatic polyisocyanate, an alicyclic polyisocyanate, or an aliphatic polyisocyanate may be adopted. The concrete examples of the organic polyisocyanate component may include all matters to be usually employed in a production of a hard polyurethane foam, for example, tolylene 2,4-diisocyanate, tolylene 2,6-diisocyanate, and a mixture thereof, diphenylmethane-4,4′-diisocyanate, 3-methyldiphenylmethane-4,4′-diisocyanate, and a composition thereof, and hexamethylene diisocyanate. Moreover, the amount of the organic polyisocyanate component to be used is 1.0 to 1.2 as an equivalent ratio of the isocyanate group relative to the hydroxyl group (NCO/OH index).

Further, in the present invention, the catalyst to be used in the reaction for producing the polyurethane foam may include, for example, a tertiary amine such as dimethylethanolamine, triethylenediamine, tetramethylpropanediamine, tetramethylhexamethylenediamine, or dimethylcyclohexylamine; and a metal catalyst such as stannous octanoate, potassium octanoate, or dibutyltin dilaurate. It is particularly preferred to use the amine catalyst and the metal catalyst in combination. These catalysts are usually employed in a proportion of about 0.1 to 5 parts by weight relative to 100 parts by weight of the polyol component. In the case where the catalyst amount is smaller than 0.1 part by weight, the catalytic effect becomes low. As a result, the reaction slows down and the desired cellular material cannot be obtained. On the other hand, when the catalyst amount is larger than 5 parts by weight, too fast reaction generates excess heat. As a result, burning (scorch) undesirably occurs inside of the obtained polyurethane foam.

In the production process of the present invention, an additive such as a foam control agent, a viscosity adjustment (or viscosity controller), a flame retardant, or an ultraviolet ray absorber may be added in addition to the above-mentioned component. Among them, the foam control agent is preferably a silicone-series foam control agent, and may include, for example, SH-193 and BY-10-540 (manufactured by Toray Dow Corning Co., Ltd.), L-5420, L-5320, L-5340 and SZ1605 (manufactured by Nippon Unicar Co., Ltd.), F305 and F341 (manufactured by Shin-Etsu Silicones (Shin-Etsu Chemical Co., Ltd.)), and others. The foam control agent is usually employed in a proportion of about 0.1 to 5 parts by weight relative to 100 parts by weight of the polyol component.

Moreover, in the production process of the polyurethane foam according to the present invention, the additive to be used in the reaction is added with the aims of lowering the viscosity of the polyol component and keeping the balance of the reaction ratio between the polyol component and the organic polyisocyanate component. The additive for lowering the viscosity and satisfying these aims may include a flame retardant such as a chlorinated paraffin, trischloroethyl phosphate or trischloropropyl phosphate, a surfactant such as nonyl phenol ether, a viscosity decreaser such as propylene carbonate, and others. These additives may be usually employed in a proportion of about 1 to 30 parts by weight relative to 100 parts by weight of the polyol component within a range in which decrease in the physical properties of the obtained polyurethane foam is acceptable.

A concrete apparatus to be used for producing the polyurethane foam from the above-mentioned materials according to the present invention may be any apparatus as long as the apparatus can uniformly mix the materials. For example, in accordance with the present invention, the polyurethane foam can be easily obtained by uniformly and continuously or discontinuously mixing the materials with the use of an experimental small mixer, a foaming machine, or other means.

### EXAMPLES

The following Examples and Comparative Examples are intended to describe this invention in further detail and should by no means be interpreted as defining the scope of the invention.

Moreover, in Examples, the hydroxyl value and the physical properties of the polyurethane foam were evaluated as follows. Hydroxyl value: An amount (mg) of potassium hydroxide corresponding to an amount of OH group in 1 g of a polyol component was measured. Viscosity: A viscosity was measured by using an E-type viscosimeter. Mechanical properties: A tensile strength (kg/cm²) and an elongation (%) were evaluated in accordance with JIS K6301. Density (kg/m³): A density was evaluated in accordance with JISK6401. 25% Hardness (g/cm²): 25% hardness was evaluated based on JIS K6402.

### Production Example 1

In a round bottom flask equipped with an agitator, a thermometer, a water separator and a nitrogen gas inlet, 624 parts by weight of ε-caprolactone (“PLACCEL M”, manufactured by Daicel Chemical Industries, Ltd.), 340 parts by weight of δ-valerolactone, and 35 parts by weight of trimethylolpropane as an initiator were charged, and the mixture was subjected to a polymerization reaction at 180° C. for 6 hours under a nitrogen flow. After confirming that the total content of the residual ε-caprolactone and δ-valerolactone became not more than 2% by weight relative to the whole reaction mixture, the residual ε-caprolactone and δ-valerolactone were removed by gradual vacuuming up with a vacuum pump so that the total content thereof became not more than 1%. Thus, a liquid copolymerized lactone polyol A was obtained which had a hydroxyl value of 56.4 KOHmg/g, an acid value of 0.06 KOHmg/g, a water content of 0.005%, a viscosity at 25° C. of 2600 mPa·s, and a number average molecular weight of 7,000.

### Production Example 2

A liquid copolymerized lactone polyol B was obtained in the same manner as Production Example 1 except for using 214 parts by weight of ε-caprolactone, 750 parts by weight of δ-valerolactone, and 35 parts by weight of trimethylolpropane as an initiator. The obtained lactone polyol B had a hydroxyl value of 56.2 KOHmg/g, an acid value of 0.08 KOHmg/g, a water content of 0.005%, a viscosity at 25° C. of 7500 mPa·s, and a number average molecular weight of 3,000.

### Production Example 3

A copolymerized lactone polyol C was obtained in the same manner as Production Example 1 except for using 971 parts by weight of ε-caprolactone, 150 parts by weight of δ-valerolactone, and 35 parts by weight of trimethylolpropane as an initiator. The obtained lactone polyol C had a hydroxyl value of 56.2 KOHmg/g, an acid value of 0.05 KOHmg/g, a water content of 0.004%, and a number average molecular weight of 3,000. This lactone polyol C was in the form of a wax at an ordinary temperature.

### Production Example 4

A liquid copolymerized lactone polyol D was obtained in the same manner as Production Example 1 except for using 631 parts by weight of ε-caprolactone, 237 parts by weight of δ-valerolactone, and 133 parts by weight of trimethylolpropane as an initiator. The obtained lactone polyol D had a hydroxyl value of 56.3 KOHmg/g, an acid value of 0.06 KOHmg/g, a water content of 0.006%, a viscosity at 25° C. of 1800 mPa·s, and a number average molecular weight of 800.

### Production Example 5

A liquid copolymerized lactone polyol E was obtained in the same manner as Production Example 1 except for using 624 parts by weight of ε-caprolactone, 364 parts by weight of δ-valerolactone, and 12 parts by weight of 1,6-hexanediol as an initiator. The obtained lactone polyol E had a hydroxyl value of 12.5 KOHmg/g, an acid value of 0.08 KOHmg/g, a water content of 0.004%, a viscosity at 25° C. of 100000 mPa·s or more, a viscosity at 40° C. of 63,000 mPa·s, and a number average molecular weight of 9,000.

### Example 1

The copolymerized lactone polyol A (67.4 parts by weight) obtained in Production Example 1, and 3 parts by weight of a ring-opening addition polymerization product of ε-caprolactone with trimethylolpropane [hydroxyl value: 540, “PLACCEL 303”, manufactured by Daicel Chemical Industries, Ltd.] were used to prepare a polyol component mixture. The calculated hydroxyl value in the polyol component mixture was 77 KOHmg/g. The viscosity of the polyol component mixture measured by an E-type viscosimeter was 7100 mPa·s at 25° C. To the polyol component mixture were added 2 parts by weight of water as a foaming agent, 1.2 parts by weight of “SG-193” (manufactured by Toray Dow Corning Co., Ltd.) as a foam control agent, 0.3 part by weight of diazobicyclooctane (DABCO33LV) as an amine catalyst, and 0.1 part by weight of dibutyltin dilaurate (DBTDL) as a tin catalyst. After stirring the mixture, 28 parts by weight of tolylene diisocyanate [TDI-80, manufactured by Nippon Polyurethane Industry Co., Ltd.] was added thereto, then the resulting mixture was strongly stirred at a room temperature for 25 seconds and was allowed to foam freely, and a soft polyurethane foam was accordingly obtained. Incidentally, the NCO/OH index (equivalent ratio) at this time was 1.10.

### Examples 2 to 5 and Comparative Examples 1 to 3

Soft urethane foams were obtained in the same manner as Example 1 except for using materials and formulations shown in Table 1. Moreover, physical properties of the obtained foams were also described in Table 1.

TABLE 1

| | | | | | | | Comparative | | |
|---|---|---|---|---|---|---|---|---|---|
| | | Examples | | | | | Examples | | |
| | | 1 | 2 | 3 | 4 | 5 | 1 | 2 | 3 |
| TDI-80 | | 28 | 28 | 28 | 28 | 28 | 28 | 28 | 26 |
| Polyol component | A | 67 | | 62 | 33.5 | 24 | 20 | | |
| | B | | 67 | | | | | | |
| | C | | | | | | | 34 | |
| | D | | | 8 | | | | | |
| | E | | | | | | | | 34 |
| GP-3000 | | | | | 33.5 | 44 | 47 | 34 | 34 |
| PCL303 | | 3 | 3 | | 3 | | | | |
| TE-300 | | | | | | 3 | 3 | | 3 |

| | | | | | | | | |
|---|---|---|---|---|---|---|---|---|
| Water | 2 | 2 | 2 | 2 | 2 | 2 | 2 | 2 |
| Foam control agent | 1.2 | 1.2 | 1.2 | 1.2 | 1.2 | 1.2 | 1.2 | 1.2 |
| Amine catalyst | 0.3 | 0.3 | 0.3 | 0.3 | 0.3 | 0.3 | 0.3 | 0.3 |
| Tin catalyst | 0.1 | 0.1 | 0.1 | 0.1 | 0.1 | 0.1 | 0.1 | 0.1 |
| NCO/OH Index | 1.1 | 1.1 | 1.1 | 1.1 | 1.1 | 1.1 | 1.1 | 1.1 |
| Viscosity of polyol | 3500 | 3500 | 3400 | 1100 | 800 | 800 | 1500 | 6700 |
| component mixture | | | | | | | | |
| (mPa · s, 25° C.) | | | | | | | | |
| OH Value of polyol | 77 | 77 | 74 | 77 | 78 | 78 | 78 | 65 |
| component mixture | | | | | | | | |
| (KOHmg/g) | | | | | | | | |
| Foam density (kg/m³) | 35.5 | 35.8 | 35.7 | 35.5 | 34.8 | 35.3 | 35.6 | 34.2 |
| Hardness | 19.5 | 18.7 | 15.5 | 19.5 | 17.5 | 12.5 | 19.0 | 15.3 |
| Tensile strength | 20.5 | 19.5 | 16.8 | 17.3 | 14.3 | 11.7 | 17.7 | 9.3 |
| (MPas) | | | | | | | | |
| Elongation at break | 250 | 240 | 280 | 200 | 180 | 130 | 210 | 300 |
| (%) | | | | | | | | |

Polyol component
PCL303: OH value = 540, viscosity: 1700 mPa · s (25° C.), Daicel Chemical Industries, Ltd.
SANNIX GP-3000: OH value = 56, viscosity: 300 mPa · s (25° C.), Sanyo Chemical Industries, Ltd.
SANNIX TE-300: OH value = 560, viscosity: 540 mPa · s (25° C.), Sanyo Chemical Industries, Ltd.
TDI-80: Tolylene diisocyanate, Nippon Polyurethane Industry Co., Ltd.
Amine catalyst: DABCO33LV
Tin catalyst: DBTDL (dibutyltin dilaurate), Sankyo Air Products Co., Ltd.
Foam control agent: SH-193, Toray Dow Corning Co., Ltd.

### INDUSTRIAL APPLICABILITY

According to the present invention, a soft polyurethane foam excellent in mechanical properties can be obtained by using only water as a foaming agent. The soft polyurethane foam is producible without using as a foaming agent, chlorofluorocarbons causing ozone layer destruction, and further without using as a foaming agent, low-boiling point organic solvents inviting the danger of fire.

1. A process for producing a polyurethane foam, which comprises allowing an organic polyisocyanate component to react with a polyol component in the presence of a catalyst with water as a foaming agent, wherein
the polyol component comprises at least 30% by weight of a copolymerized lactone polyol having a hydroxyl value of 20 to 350 KOHmg/g and being in the form of a liquid at an ordinary temperature, and the copolymerized lactone polyol is obtained by ring opening copolymerization of ε-caprolactone and δ-valerolactone in a molar ratio [ε-caprolactone/δ-valerolactone] of 80/20 to 20/80 with a low molecular weight compound having at least two active hydrogen groups as an initiator; and
the hydroxyl value of the polyol component is 40 to 400 KOHmg/g.

2. A process for producing a polyurethane foam according to claim 1, wherein the low molecular weight compound having at least two active hydrogen groups comprises at least one member selected from the group consisting of ethylene glycol, diethylene glycol, propylene glycol, dipropylene glycol, 1,4-butanediol, 1,5-pentanediol, neopentyl glycol, 1,6-hexanediol, glycerin, trimethylolpropane, triethanolamine and pentaerythritol.

3. A process for producing a polyurethane foam according to claim 1, wherein the viscosity of the copolymerized lactone polyol is not more than 20,000 mPa·s at 25° C.
